(19) United States
(12) Patent Application Publication
(10) Pub. No.: US 2026/0002675 A1
(43) Pub. Date: Jan. 1, 2026

(54) INSULATION FOR AN OVEN APPLIANCE AND METHODS OF ASSEMBLING THE SAME

(71) Applicant: Haier US Appliance Solutions, Inc., Wilmington, DE (US)

(72) Inventors: Marcelo Torrentes, Louisville, KY (US); Jeremy Michael Green, Louisville, KY (US)

(21) Appl. No.: 18/754,993

(22) Filed: Jun. 26, 2024

(51) Int. Cl. F24C 15/20; F16L 59/02

(52) U.S. Cl. CPC F24C 15/2042; F16L 59/021

(57) ABSTRACT

An oven appliance may include a cabinet. The cabinet may include a cooking chamber disposed within the cabinet and a rear panel at a rear thereof. The oven appliance may include a ventilation assembly for exhausting gas from the cooking chamber. The ventilation assembly may include a chamber duct in fluid communication between the cooking chamber and an exhaust port at the rear of the cabinet. The oven appliance may include an exhaust insulation panel. The exhaust insulation panel may include a sheet of insulation material positioned over the chamber duct. The sheet of insulation material may be complementary to an outer surface of the chamber duct. The sheet of insulation may define one or more vertical slits therethrough. The sheet of insulation material may be secured to the chamber duct via engagement between the one or more vertical slits and the rear panel.

### FIELD OF THE DISCLOSURE

The present subject matter relates generally to an oven appliance, and more particularly to insulation for an oven appliance and methods for assembling the same.

### BACKGROUND OF THE DISCLOSURE

Conventional residential and commercial oven appliances generally include a cabinet that includes a cooking chamber for receipt of food items for cooking. Multiple heating elements are positioned within the cooking chamber to provide heat to food items located therein. The heating elements can include, for example, radiant heating elements, such as a bake heating assembly positioned at a bottom of the cooking chamber, or a separate broiler heating assembly positioned at a top of the cooking chamber. In addition, conventional oven appliances can include a cooktop positioned on a top of the appliance that includes one or more heating elements, such as electric heaters, gas burners, or induction heating elements.

Oven appliances also can include vent assemblies for venting steam, smoke, and other gases from the cooking chamber during operation of the oven appliance. However, these vent assemblies can have certain drawbacks. For instance, during operation, the vent assemblies can radiate heat to areas surrounding the cooking chamber, such as a cabinet of the oven appliance or storage cabinetry surrounding the oven appliance. If the vent assemblies are not properly insulated, the heat from the vent assemblies can also radiate to areas surrounding the cooking chamber. This heat can result in unwanted temperatures in such areas. Moreover, oven appliances often utilize mechanical fasteners to secure insulation to the vent assemblies of the oven appliance. The use of these mechanical fasteners can be tedious, adding manufacturing costs or potentially reducing durability of the insulation.

Accordingly, an oven appliance that obviates one or more of the above-mentioned drawbacks would be beneficial.

### BRIEF DESCRIPTION OF THE DISCLOSURE

Aspects and advantages of the invention will be set forth in part in the following description, or may be obvious from the description, or may be learned through practice of the invention.

In one exemplary aspect of the present disclosure, an oven appliance is provided. The oven appliance may include a cabinet. The cabinet may include a cooking chamber disposed within the cabinet and a rear panel at a rear thereof. The oven appliance may include a ventilation assembly for exhausting gas from the cooking chamber. The ventilation assembly may include a chamber duct in fluid communication between the cooking chamber and an exhaust port at the rear of the cabinet. The oven appliance may include an exhaust insulation panel. The exhaust insulation panel may include a sheet of insulation material positioned over the chamber duct. The sheet of insulation material may be complementary to an outer surface of the chamber duct. The sheet of insulation may define one or more vertical slits therethrough. The sheet of insulation material may be secured to the chamber duct via engagement between the one or more vertical slits and the rear panel.

In another exemplary aspect of the present disclosure, an oven appliance is provided. The oven appliance may include a cabinet. The cabinet may include a cooking chamber disposed within the cabinet and an internal rear panel attached to a rear wall of the cooking chamber. The oven appliance include a ventilation assembly for exhausting gas from the cooking chamber. The ventilation assembly may include a chamber duct in fluid communication between the cooking chamber and an exhaust port at the rear of the cabinet. The oven appliance may include an exhaust insulation panel. The exhaust insulation panel may include a sheet of insulation material positioned over the chamber duct. The sheet of insulation material may include a front face, a first side face, and a second side face. The front face may include a first edge and a second edge being in parallel arrangement. The first side face may extend from the first edge. The second edge may extend from the second edge. The front face, the first side face, and the second side face may be complementary to an outer surface of the chamber duct. The first side face or the second side face may define one or more vertical slits therethrough. The sheet of insulation material may be secured to the chamber duct via engagement between the one or more vertical slits and the internal rear panel.

In yet another exemplary aspect of the present disclosure, a method of assembling an oven appliance is provided. The method may include bending a sheet of insulation material to form a shape complementary to a chamber duct. The method may also include engaging the sheet of insulation material with a rear panel of the oven appliance at one or more vertical slits formed through the sheet of insulation material. The sheet of insulation may be positioned over the chamber duct.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front perspective view of an oven appliance according to one or more exemplary embodiments of the present subject matter.

FIG. 2 provides a side cross-sectional view of the exemplary oven appliance of FIG. 1 according to one or more exemplary embodiments of the present subject matter.

FIG. 3 provides a front perspective view of the exemplary oven appliance of FIG. 1 with a cooktop of the oven appliance removed to reveal a ventilation assembly of the oven appliance.

FIG. 4 provides a perspective view of an exhaust insulation panel of the exemplary oven appliance of FIG. 1.

FIG. 5 provides a front perspective view of a portion of the exemplary ventilation assembly of FIG. 3.

FIG. 6 provides a rear perspective view of a portion of the exemplary ventilation assembly of FIG. 3.

FIG. 7 provides a flowchart of a method of assembling an oven appliance according to one or more exemplary embodiments of the present subject matter.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a 10 percent margin (i.e., including values within ten percent greater or less than the stated value). In this regard, for example, when used in the context of an angle or direction, such terms include within ten degrees greater or less than the stated angle or direction (e.g., “generally vertical” includes forming an angle of up to ten degrees in any direction, such as, clockwise or counterclockwise, with the vertical direction V).

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations.

Except as explicitly indicated otherwise, recitation of a singular processing element (e.g., “a controller,” “a processor,” “a microprocessor,” etc.) is understood to include more than one processing element. In other words, “a processing element” is generally understood as “one or more processing element.” Furthermore, barring a specific statement to the contrary, any steps or functions recited as being performed by “the processing element” or “said processing element” are generally understood to be capable of being performed by “any one of the one or more processing elements.” Thus, a first step or function performed by “the processing element” may be performed by “any one of the one or more processing elements,” and a second step or function performed by “the processing element” may be performed by “any one of the one or more processing elements and not necessarily by the same one of the one or more processing elements by which the first step or function is performed.” Moreover, it is understood that recitation of “the processing element” or “said processing element” performing a plurality of steps or functions does not require that at least one discrete processing element be capable of performing each one of the plurality of steps or functions.

Generally, an oven appliance may be provided in some aspects of the present disclosure. The oven appliance may include a cabinet that may include cooking chamber. One or more heating elements may be positioned within or otherwise in thermal communication with the cooking chamber to selectively cook or heat items (e.g., food items) placed within the cooking chamber. The oven appliance can also include a ventilation assembly for cooling components positioned within or proximate to the cabinet or for venting (e.g., exhausting) steam, smoke, or other gases that may be produced within the cooking chamber during operation of the oven appliance. In order to prevent or mitigate heat from radiating outward from ducts of the ventilation assembly, insulating material may be placed around the ducts. However, if the ventilation assembly, and more particularly, a chamber duct of the ventilation assembly, are left uninsulated (e.g., due to improper assembly or failure of external fasteners), the ventilation assembly can radiate heat to areas surrounding the cabinet of the oven appliance resulting in unwanted temperature rise in surrounding areas or electrical components.

Notably, embodiments of the present subject matter are generally directed to an exhaust insulation panel of the ventilation assembly of the oven appliance. In several embodiments, the exhaust insulation panel is configured as a unibody (e.g., a single unit or piece of insulation) that is shaped complementary to a chamber duct of the ventilation assembly. Specifically, the exhaust insulation panel defines one or more vertical slits therethrough that advantageously locate and secure the exhaust vent insulation to a rear panel or wall of the oven appliance (e.g., via the one or more slits engaging with the rear panel or wall).

In should be appreciated that, by utilizing vertical slits defined through the exhaust insulation panel to locate and secure the exhaust insulation panel to the ventilation assembly, advantages may be obtained (e.g., when compared to traditional or conventional assembly methods that utilize external fasteners, such as wire, twist ties, screws, etc., to attach insulation to the chamber duct or that assembly methods that require the insulation to engage with itself to be secured to the chamber duct). Specifically, during assembly of the oven appliance, the use of external fasteners may increase production time and part count. Moreover, the use of additional or external fasteners may require precise placement and installation from an operator. Such precise placement and installation may increase production time and decrease the reliability of the fasteners as the chance of operator error is increased. However, exhaust insulation panels that do not require additional or external fasteners to be secured to the ventilation assembly have quicker installation times and reduce or mitigate the occurrence of operator error (e.g., in comparison to existing oven appliances).

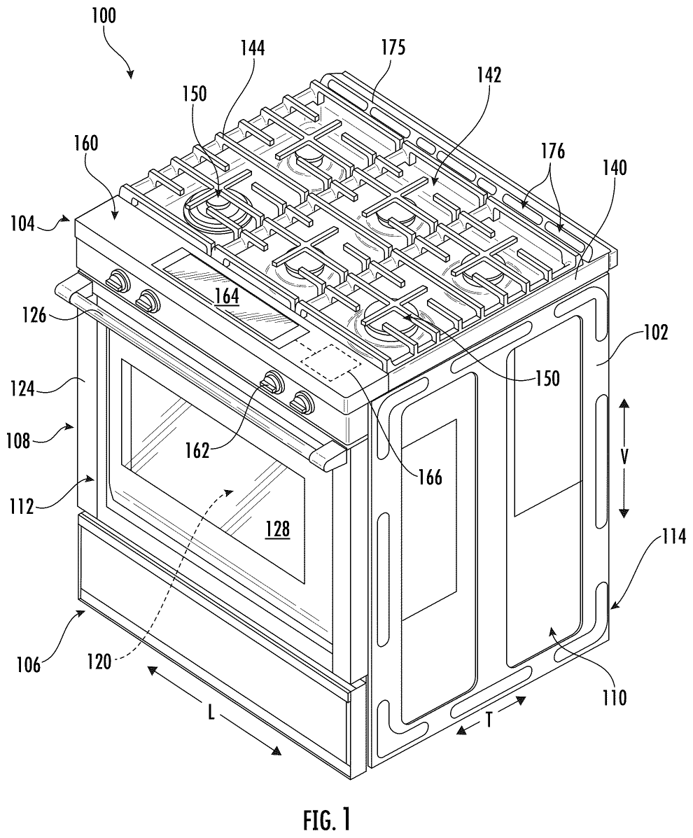

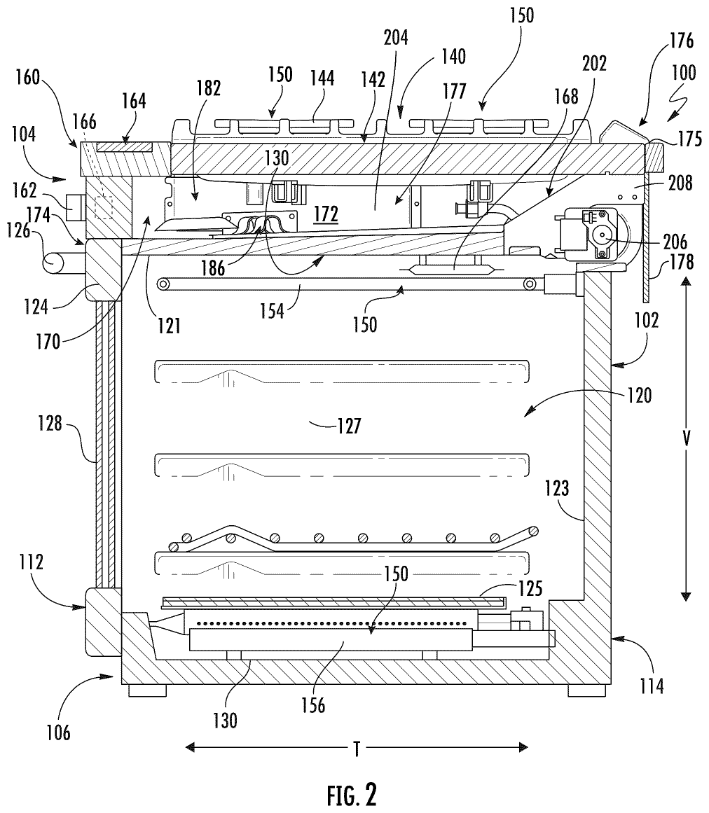

Referring now to the figures, FIGS. 1 and 2 provide views of an oven appliance 100 according to one or more exemplary embodiments of the present subject matter. Oven appliance 100 generally defines a vertical direction V, a lateral direction L, and a transverse direction T, each of which is mutually perpendicular, such that an orthogonal coordinate system is generally defined. As will be understood by those skilled in the art, oven appliance 100 is provided by way of example only, and the present subject matter may be used in any suitable oven appliance. Thus, the present subject matter may be used with other oven appliances having different configurations, such as wall ovens, electric ovens, gas ovens, microwave ovens, etc.

In some embodiments, the oven appliance 100 includes a cabinet 102. The oven appliance 100 may also include a cooking chamber 120 positioned within the cabinet 102. The cooking chamber 120 may define a cooking cavity for the receipt of one or more items (e.g., food items) to be cooked or heated. However, it should be appreciated that oven appliance 100 is provided by way of example only, and aspects of the present subject matter may be used in any suitable oven appliance, such as a double oven range appliance. Thus, the example embodiment shown in FIG. 1 is not intended to limit the present subject matter to any particular cooking chamber configuration or arrangement. Indeed, aspects of the present subject matter may be applied to cooking chambers for any suitable appliance.

The cabinet 102 may extend between a top 104 and a bottom 106 along the vertical direction V, between a first side 108 (left side when viewed from front) and a second side 110 (right side when viewed from front) along the lateral direction L, and between a front 112 and a rear 114 along the transverse direction T. Additionally, the oven appliance 100 may include a door 124 rotatably attached to cabinet 102 in order to permit selective access to the cooking chamber 120. Handle 126 is mounted to door 124 to assist a user with opening and closing door 124 in order to access cooking chamber 120. As an example, a user can pull on handle 126 mounted to door 124 to open or close door 124 and access cooking chamber 120. One or more transparent viewing windows 128 (e.g., FIG. 1) may be defined within door 124 to provide for viewing the contents of cooking chamber 120 when door 124 is closed and also assist with insulating cooking chamber 120.

In general, cooking chamber 120 is defined by a plurality of chamber walls (e.g., FIG. 2). Specifically, cooking chamber 120 may be defined by a top wall 121, a rear wall 123, a bottom wall 125, and two sidewalls 127. The top wall 121 and the bottom wall 125 may be spaced apart along the vertical direction V. The two sidewalls 127 (e.g., a left sidewall and a right sidewall) may be spaced apart along the lateral direction L. The rear wall 123 may additionally extend between the top wall 121 and the bottom wall 125 as well as between the two sidewalls 127 and is spaced apart from door 124 along the transverse direction T. In this manner, when door 124 is in the closed position the cooking cavity of the cooking chamber 120 is defined by the door 124 and the top wall 121, the rear wall 123, the bottom wall 125, the two sidewalls of the cooking chamber 120. In order to insulate cooking chamber 120, oven appliance 100 includes insulating gaps defined between the walls of the cooking chamber 120 (e.g., the top wall 121, the rear wall 123, the bottom wall 125, and the two sidewalls 127) and the cabinet 102. According to an exemplary embodiment, the insulating gaps can be filled with an insulating material, such as insulating foam or fiberglass, for insulating cooking chamber 120.

In some embodiments, oven appliance 100 includes a cooktop 140. Cooktop 140 is positioned at or adjacent top 104 of cabinet 102 such that it is positioned above cooking chamber 120. Specifically, cooktop 140 includes a top panel 142 positioned proximate top 104 of cabinet 102. By way of example, top panel 142 may be constructed of glass, ceramics, enameled steel, and combinations thereof. One or more grates 144 may be supported on a top surface of top panel 142 for supporting cooking utensils, such as pots or pans, during a cooking process.

Oven appliance 100 may further include one or more heating elements (identified generally by reference numeral 150) for selectively heating cooking utensils positioned on grates 144 or food items positioned within cooking chamber 120. For example, referring to FIG. 1, heating elements 150 may be gas burners 150. Specifically, a plurality of gas burners 150 are mounted within or on top of top panel 142 underneath grates 144 that supports cooking utensils over the gas burners 150 while gas burners 150 provide thermal energy to cooking utensils positioned thereon, e.g., to heat food or cooking liquids (e.g., oil, water, etc.). Gas burners 150 can be configured in various sizes so as to provide e.g., for the receipt of cooking utensils (e.g., pots, pans, etc.) of various sizes and configurations and to provide different heat inputs for such cooking utensils. According to alternative embodiments, oven appliance 100 may have other cooktop configurations or burner elements.

As will be understood by those skilled in the art, the cooktop 140 of oven appliance 100 is provided by way of example only, and the present subject matter may be used in any suitable oven appliance with any suitable cooktop configuration. Thus, the present subject matter may be used with other oven appliances having different cooktop configurations, such as electric cooktops.

In addition, heating elements 150 may be positioned within or may otherwise be in thermal communication with cooking chamber 120 for regulating the temperature within cooking chamber 120. Specifically, an upper gas heating element 154 (also referred to as a broil heating element or gas burner) may be positioned in cabinet 102, e.g., at a top portion of cooking chamber 120, and a lower gas heating element 156 (also referred to as a bake heating element or gas burner) may be positioned at a bottom portion of cooking chamber 120. Upper gas heating element 154 and lower gas heating element 156 may be used independently or simultaneously to heat cooking chamber 120, perform a baking or broil operation, perform a cleaning cycle, etc. The size and heat output of gas heating elements 154, 156 can be selected based on the, for example, the size of oven appliance 100 or the desired heat output. Oven appliance 100 may include any other suitable number, type, and configuration of heating elements 150 within cabinet 102 or on cooktop 140. For example, oven appliance 100 may further include electric heating elements, induction heating elements, or any other suitable heat generating device.

A control panel assembly 160 is located within convenient reach of a user of the oven appliance 100. For this example embodiment, control panel assembly 160 is positioned at a top 104 and front 112 of cabinet 102, e.g., above door 124 along the vertical direction V and forward of cooktop 140 along the transverse direction T. Control panel assembly 160 includes knobs 162 that are each associated with one of heating elements 150. In this manner, knobs 162 allow the user to activate each heating element 150 and determine the amount of heat input provided by each heating element 150 for cooking food items within cooking chamber 120 or on cooktop 140. Although shown with knobs 162, it should be understood that knobs 162 and the configuration of oven appliance 100 shown in FIG. 1 is provided by way of example only. More specifically, control panel assembly 160 may include various input components, such as one or more of a variety of touch-type controls, electrical, mechanical or electro-mechanical input devices including rotary dials, push buttons, and touch pads. Control panel assembly 160 may also be provided with one or more graphical display devices or display components, such as a digital or analog display device designed to provide operational feedback or other information to the user such as e.g., whether a particular heating element 150 is activated or the rate at which the heating element 150 is set. Indeed, according to the illustrated embodiment, control panel assembly 160 includes a display assembly 164, such as a liquid crystal display with an interactive display and interface.

Generally, oven appliance 100 may include a controller 166 in operative communication with control panel assembly 160. Control panel assembly 160 of oven appliance 100 may be in communication with controller 166 via, for example, one or more signal lines or shared communication busses, and signals generated in controller 166 operate oven appliance 100 in response to user input via user input devices, e.g., control knobs 162 or display assembly 164. Input/Output (“I/O”) signals may be routed between controller 166 and various operational components of oven appliance 100 such that operation of oven appliance 100 can be regulated by controller 166. In addition, controller 166 may also be in communication with one or more sensors, such as temperature sensor 168 (FIG. 2), which may be used to measure temperature inside cooking chamber 120 and provide such measurements to the controller 166. Although temperature sensor 168 is illustrated at a top and rear of cooking chamber 120, it should be appreciated that other sensor types, positions, and configurations may be used according to alternative embodiments.

Controller 166 is a “processing device” or “controller” and may be embodied as described herein. Controller 166 may include a memory and one or more microprocessors, microcontrollers, application-specific integrated circuits (ASICS), CPUs or the like, such as general or special purpose microprocessors operable to execute programming instructions or micro-control code associated with operation of oven appliance 100, and controller 166 is not restricted necessarily to a single element. The memory may represent random access memory such as DRAM, or read only memory such as ROM, electrically erasable, programmable read only memory (EEPROM), or FLASH. In one embodiment, the processor executes programming instructions stored in memory. The memory may be a separate component from the processor or may be included onboard within the processor. Alternatively, controller 166 may be constructed without using a microprocessor, e.g., using a combination of discrete analog or digital logic circuitry (such as switches, amplifiers, integrators, comparators, flip-flops, AND gates, and the like) to perform control functionality instead of relying upon software.

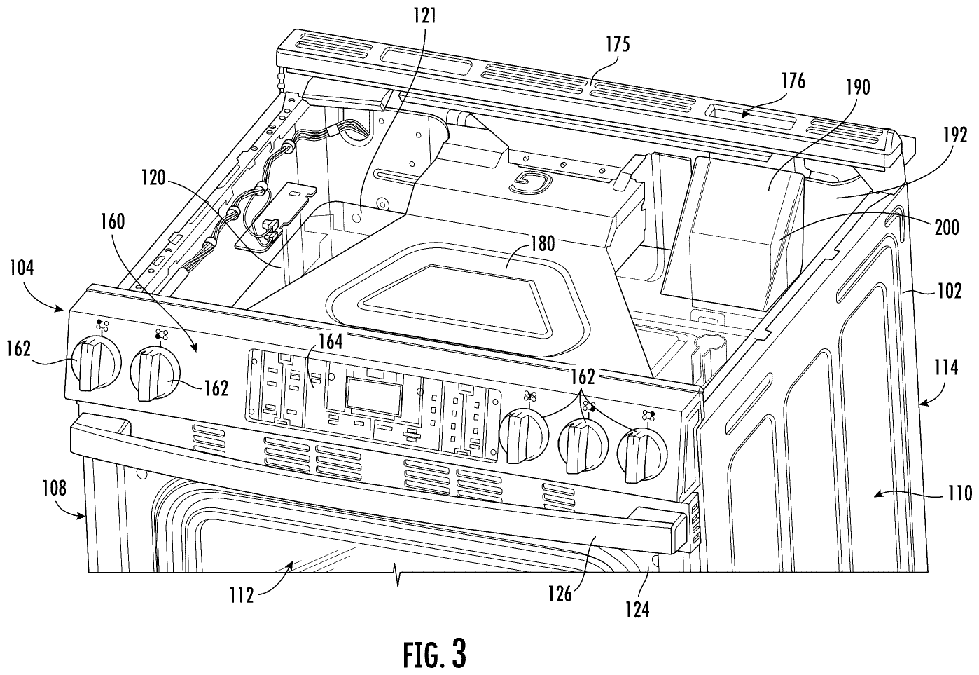

Referring now to FIGS. 2 and 3, oven appliance 100 further includes a ventilation assembly 170 defining a primary air passage 172. Ventilation assembly 170 may generally be configured to direct air through (e.g., into and out of) a portion of the cabinet 102. In some embodiments, the cooking chamber 120 is positioned within cabinet 102 such that a primary air passage 172 is defined within an open region 177 between the cooktop 140 and the cooking chamber 120 (e.g., a top surface 129 of the top wall 121 of the cooking chamber 120). Thus, primary air passage 172 may be at least partially defined by a height or space along the vertical direction V between a top panel and bottom panel of the cabinet.

As illustrated, primary air passage 172 also extends along the transverse direction T. In particular, primary air passage 172 may extend between a primary inlet 174 and one or more exhaust ports 176. Primary inlet 174 may be positioned at or adjacent the front portion 35 of cabinet 102. In some such embodiments, primary inlet 174 of ventilation assembly 170 is also positioned above and adjacent or proximate to door 124 (e.g., when door 124 is in the closed position).

In some embodiments, an exhaust trim piece 175 may generally be positioned adjacent or proximate a rear panel 178 (e.g., a panel positioned at the rear 114) of the cabinet 102. The exhaust trim piece 175 may define the one or more exhaust ports 176 therethrough for discharging hot air from within cabinet 102, and more particularly, from the primary air passage 172. For example, the exhaust trim piece may be disposed beside or attached to the cooktop 140 of the oven appliance 100 at or proximate to rear panel 178 of cabinet 102. By placing the exhaust trim piece 175 and the exhaust port(s) 176 in a top, back corner of cabinet 102, hot air may be exhausted up and away from both oven appliance 100 and its user.

However, it should be appreciated that in alternative exemplary embodiments, the exhaust port(s) 176 may be defined in the rear panel 178 of cabinet 102, such that it is not visible to the user, or may be positioned at any other suitable location. Also alternatively, exhaust port(s) 176 may be coupled to an external exhaust duct which routes heated air out of the room or ambient environment in which oven appliance 100 is located.

In some embodiments, a primary duct 180 (e.g., FIG. 3) defines at least a portion of primary air passage 172. For example, primary duct 180 may be mounted on the top surface 129 of the top wall 121 of the cooking chamber 120. Primary duct 180 may extend along the transverse direction T between a duct inlet 182 and exhaust port 176. Duct inlet 182 may be positioned toward a front portion of oven appliance 100 (e.g., closer, along the transverse direction T, to control panel assembly 160 and front 112 of cabinet 102 than the rear 114 of oven appliance 100). In certain embodiments, duct inlet 182 is positioned within a front half of oven appliance 100 along the transverse direction T. In some such embodiments, duct inlet 182 may be attached to control panel assembly 160 such that electronics housed within the control panel assembly 160 are placed in direct, sealed fluid communication with primary air passage 172. In such a configuration, air is drawn through duct inlet 182 only from the electronics housing and not from elsewhere within cabinet 102. However, in alternative exemplary embodiments, duct inlet 182 is open to the rest of the open region 177 (e.g., between top wall 121 and cooktop 140).

In some embodiments, a fan 184 is positioned within the cabinet 102 in fluid communication with primary air passage 172. In particular fan 184 is mounted within primary air passage 172 to motivate air therethrough. Generally, fan 184 may draw air from primary inlet 174 (e.g., through the electronics housing) and discharge it out of exhaust port(s) 176. Thus, fan 184 is positioned downstream from primary inlet 174 and upstream from exhaust port 176. According to the illustrated embodiments, fan 184 is a tangential fan that is positioned toward a back end of primary duct 180 proximate to rear panel 178 of cabinet 102. However, one skilled in the art will appreciate that any other suitable fan type, position, or configuration may be used while remaining within the scope of the present subject matter. For example, fan 184 could instead be a radial fan positioned toward a front end of primary duct 180. Indeed, any suitable fan and duct arrangement configured for exhausting air from primary inlet 174 out of exhaust port 176 may be used.

In some embodiments, a chamber duct 190 (e.g., FIG. 3) may be mounted over or in direct fluid communication with chamber vent 186. As illustrated in FIG. 3, the chamber duct 190 may be in fluid isolation from the primary duct 180 (e.g., such that air is not exchanged directly therebetween). Thus, exhaust gases (e.g., steam, smoke, or any other exhaust gases that may form during operation) from the cooking chamber 120 may flow through the through the chamber duct 190 before exiting out of the oven appliance 100 through the exhaust port(s) 176.

In certain embodiments, an internal rear panel 192 is positioned within cabinet 102 between the rear panel 178 and the rear wall 123 of the cooking chamber 120. For instance, as illustrated in FIG. 3, internal rear panel 192 may be mounted on an outer surface of cooking chamber 120. Moreover, internal rear panel 192 may span at least a portion of the cooking chamber 120 along the lateral direction L. Additionally or alternatively, internal rear panel 192 may extend along the vertical direction V between cooking chamber 120 and cooktop 140. Internal rear panel 192 may thus generally separate open region 177 from the rear panel 178.

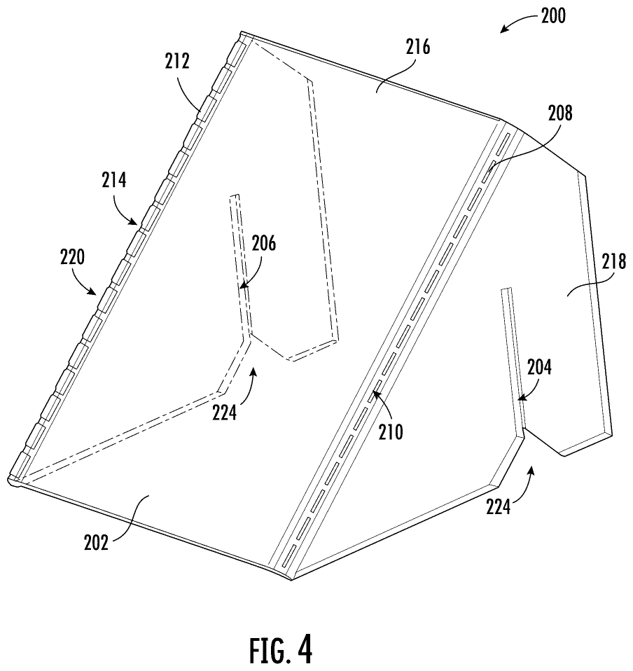

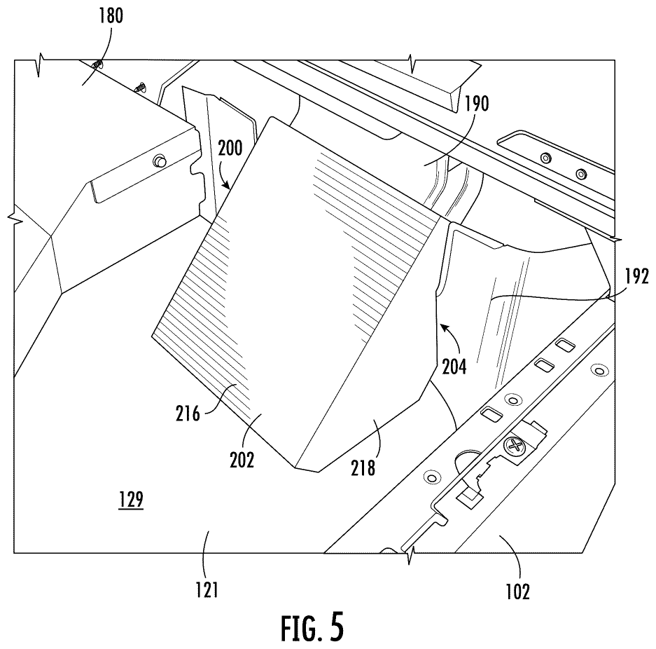

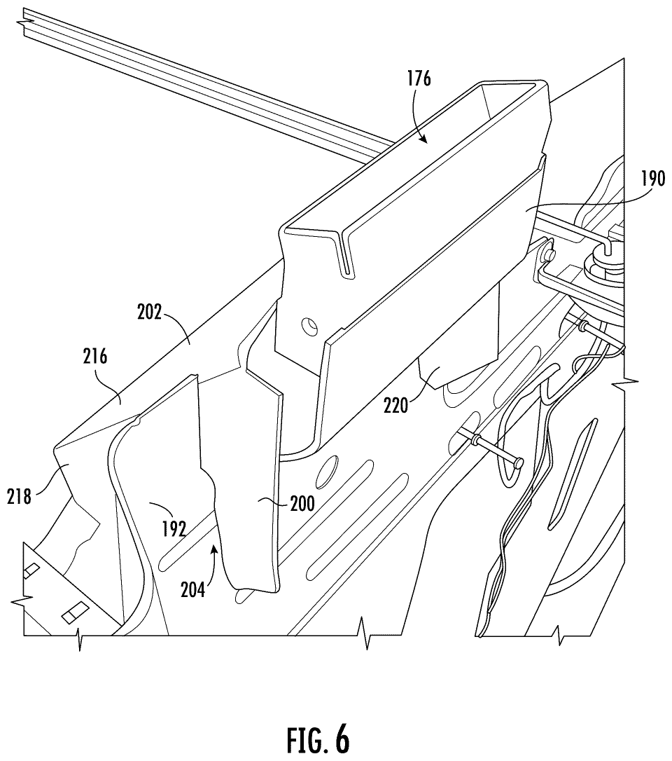

Referring now to FIGS. 3 through 6, various perspective views are provided of an exhaust insulation panel 200 configured for insulating the chamber duct 190 of the ventilation assembly 170 (e.g., during operation of the oven appliance 100). For instance, the exhaust insulation panel 200 may reduce or mitigate the radiation of heat from the chamber duct 190 during operation of the oven appliance 100. In some embodiments, the exhaust insulation panel 200 includes or is constructed from a sheet of insulation material 202. The sheet of insulation material 202 may be formed of a rigid insulative material (e.g., a rigid material that is capable of mitigating or reducing the radiation of heat from the exhaust duct to areas surrounding the exhaust duct, such as the sidewalls of the cabinet or cabinetry surrounding the oven appliance). For example, the sheet of insulation material 202 may be constructed from or include fiber glass, glass wool, stone wool, or any other suitable insulative material.

As will be appreciated in more detail below, the exhaust insulation panel 200 notably eliminates the use of external fasteners (e.g., wire, twist ties, screw, etc.) that are commonly or traditionally used to attach or secure insulation to the chamber duct 190 of an oven appliance 100. Particularly, the exhaust insulation panel 200 may advantageously utilize one or more vertical slits (e.g., a first vertical slit 204 and a second vertical slit 206) formed through the sheet of insulation material 202 to locate and securely retain the exhaust insulation panel 200 to a rear panel of the oven appliance 100, such as the internal rear panel 192 of the oven appliance 100.

The sheet of insulation material 202 may be formed into a shape that is complementary to a shape of the chamber duct 190. Particularly, the sheet of insulation material 202 may be formed into a three-sided body that covers less than all sides of the chamber duct 190. For instance, the sheet of insulation material 202 may be shaped such that the exhaust insulation panel 200 is complementary to a front face and two side faces of the chamber duct 190.

In some embodiments, the sheet of insulation material 202 includes a first set of perforations 208 positioned at a first bend location 210 and a second set of perforations 212 positioned at a second bend location 214. The first set of perforations 208 and the second set of perforations 212 may each be composed of a series of linear perforations (e.g., thin indentations or holes defined in or through the sheet of insulation material 202) of generally equal length and spaced apart at a regular interval. The second bend location 214 may generally be parallel to the first bend location 210. In this regard, during assembly of the oven appliance 100, the sheet of insulation material 202 may be bent at the first bend location 210 along the first set of perforations 208 and at the second bend location 214 along the second set of perforations 212 (e.g., by an operator of the oven appliance 100). Once bent or folded, the sheet of insulation material 202 may form a front face 216, a first side face 218, and a second side face 220. For instance, once bent or folded, the first bend location 210 may be defined between the front face 216 and the first side face 218 and the second bend location 214 may be defined between the front face 216 and the second side face 220.

In some embodiments, a first vertical slit 204 is formed through the first side face 218 and a second vertical slit 206 is formed through the second side face 220. The first vertical slit 204 and the second vertical slit 206 may be shaped and sized such that they are complementary in shape to the internal rear panel 192. For instance, the first vertical slit 204 and the second vertical slit 206 may each define a width (e.g., measured along the transverse direction T) that is approximately the same as the thickness of the internal rear panel 192. In this regard, when the exhaust insulation panel 200 is engaged with the internal rear panel 192, the first vertical slit 204 and the second vertical slit 206 may each tightly engage or interface with the internal rear panel 192. For instance, the exhaust insulation panel 200 may form an interference or a friction fit with the internal rear panel 192. Notably, the engagement between the exhaust insulation panel 200 and the internal rear panel 192 may secure the exhaust insulation panel 200 over or around the chamber duct 190 such that the exhaust insulation panel 200 does not need external fasteners to be secured to the chamber duct 190. Additionally or alternatively, the engagement between the exhaust insulation panel 200 and the internal rear panel 192 may secure the exhaust insulation panel 200 over or around the chamber duct 190 such that the exhaust insulation panel 200 does not to engage with itself to be secured to the chamber duct 190.

Moreover, the first side face 218 and the second side face 220 may each define an opening slot 224 positioned below the respective vertical slit. Each opening slot 224 may define a space that is wider than the respective vertical slit or the thickness of the internal rear panel 192. For example, each opening slot 224 may define a triangular or trapezoidal shape that may taper toward the respective vertical slit. In this regard, when an operator slides the exhaust insulation panel 200 onto the internal rear panel 192, the opening slots 224 may guide or locate the internal rear panel 192 to the first vertical slit 204 or the second vertical slit 206, respectively.

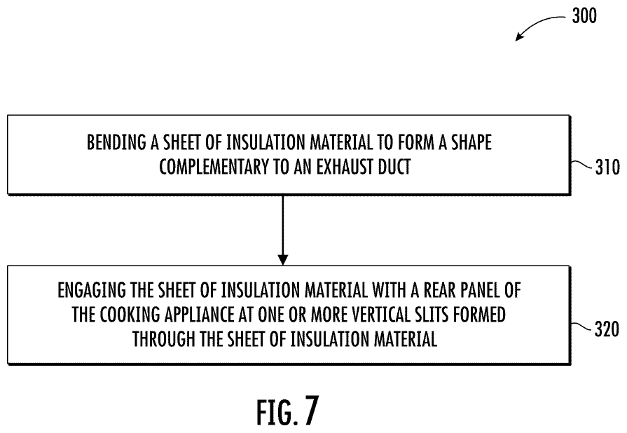

Turning now to FIG. 7, embodiments of the present subject matter also include methods such as method 300 of assembling an oven appliance illustrated in FIG. 7. Methods such as method 300 may be used to assembly any suitable oven appliance, such as but not limited to the exemplary oven appliance described above.

Method 300, at 310, may include bending a sheet of insulation material to form a shape complementary to a chamber duct of a ventilation assembly of the oven appliance. In some embodiments, bending the sheet of insulation material may include bending the sheet of insulation material at one or more bend locations defined in the sheet of insulation material. For example, the sheet of insulation material may include one or more sets of perforations at each of the one or more bend locations. The sets of perforations may include a series of linear perforations (e.g., thin indentations or holes defined in or through the sheet of insulation material) of generally equal length and spaced apart at a regular interval. The one or more sets of perforations may facilitate bending of the sheet of insulation material (e.g., for an operator of the oven appliance).

For example, in some embodiments, bending the sheet of insulation material includes bending the sheet of insulation material at a first bend location to form a first bend in the sheet of insulation material, and can further include bending the sheet of insulation material at a second bend location to form a second bend in the sheet of insulation material. In such embodiments, the second bend is generally parallel to the first bend. Also in such embodiments, bending the sheet of insulation material may be performed after an operator has obtained the sheet of insulation material and before the sheet of insulation material has been engaged with a rear panel of the oven appliance.

Bending the sheet of insulation material to form the first bend in the sheet of insulation material may include bending the sheet of insulation material along a first set of perforations defined in the sheet of insulation material, and in such embodiments, bending the sheet of insulation material to form the second bend in the sheet of insulation material may include bending the sheet of insulation along a second set of perforations defined in the sheet of insulation material. In this regard, a shape complementary to the chamber duct may be formed. In particular, the sheet of insulation material may be bent such that a three-side structure that may cover less than all of the side of the chamber duct may be formed. For instance, the sheet of insulation material may be bent such that a front face, a first side face, and a second side face are formed.

Method 300, at 320, may include engaging the sheet of insulation material with a rear panel of the oven appliance at one or more vertical slits formed through the sheet of insulation material. The sheet of insulation material may be positioned over the exhaust duct. For example, the rear panel may be an internal rear panel attached to the rear wall of the cooking chamber. The first vertical slit and the second vertical slit may engage with the internal rear panel. Particularly, the first vertical slit and the second vertical slit may slide onto the internal rear panel and form an interference or a friction fit is formed between the first vertical slit or the second vertical slit and the internal rear panel. In this regard, the sheet of insulation material may be secured to or over less than all side of the chamber duct without the user of fasteners or without the sheet of insulation material engaging with itself.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. An oven appliance comprising:
a cabinet comprising a cooking chamber disposed within the cabinet and a rear panel at a rear thereof;
a ventilation assembly comprising a chamber duct in fluid communication between the cooking chamber and an exhaust port at the rear of the cabinet; and
an exhaust insulation panel comprising:
a sheet of insulation material positioned over the chamber duct, the sheet of insulation material being complementary to an outer surface of the chamber duct, the sheet of insulation defining one or more vertical slits therethrough,
wherein the sheet of insulation material is secured to the chamber duct via engagement between the one or more vertical slits and the rear panel.

2. The oven appliance of claim 1, wherein the sheet of insulation material comprises a front face, a first side face extended downward from a first edge of the front face, and a second side face extended downward from a second edge of the front face, wherein the one or more vertical slits comprises a first vertical slit and a second vertical slit, wherein the first vertical slit is formed through the first side face, and wherein the second vertical slit is formed through the second side face.

3. The oven appliance of claim 2, wherein the sheet of insulation material comprises a first bend and a second bend, wherein the first bend is defined between the front face and the first side face, and wherein the second bend is defined between the front face and the second side face.

4. The oven appliance of claim 3, wherein the second bend is generally parallel to the first bend.

5. The oven appliance of claim 3, wherein the sheet of insulation material further comprises a first set of perforations and a second set of perforations, wherein the first set of perforations are defined at a first bend location corresponding to the first bend, and wherein the second set of perforations are defined at a second bend location corresponding to the second bend.

6. The oven appliance of claim 1, wherein the sheet of insulation material is secured to the chamber duct without utilizing external fasteners.

7. The oven appliance of claim 1, wherein the sheet of insulation material is secured to the chamber duct without the sheet of insulation material engaging with itself.

8. The oven appliance of claim 1, wherein the chamber duct defines a plurality of sides, the plurality of sides comprising a front wall, a rear wall, a first side wall, and a second side wall, wherein the sheet of insulation material is secured to less than all sides of the plurality of sides of the chamber duct.

9. The oven appliance of claim 1, wherein the cooking chamber comprises a top wall, wherein the cabinet comprises an exhaust trim piece at a top side and a rear of the cabinet, and wherein the chamber duct is extended between the top wall of the cooking chamber and the exhaust trim piece.

10. The oven appliance of claim 1, wherein the rear panel is attached to a rear wall of the cooking chamber.

11. An oven appliance comprising:
a cabinet comprising a cooking chamber disposed within the cabinet and an internal rear panel attached to a rear wall of the cooking chamber;
a ventilation assembly for exhausting gas from the cooking chamber, the ventilation assembly comprising a chamber duct in fluid communication between the cooking chamber and an exhaust port at the rear of the cabinet; and
an exhaust insulation panel comprising:
a sheet of insulation material positioned over the chamber duct, the sheet of insulation material comprising a front face, a first side face, and a second side face, the front face comprising a first edge and a second edge being in parallel arrangement, the first side face extending from the first edge, the second edge extending from the second edge, wherein the front face, the first side face, and the second side face are complementary to an outer surface of the chamber duct, the first side face or the second side face defining one or more vertical slits therethrough,
wherein the sheet of insulation material is secured to the chamber duct via engagement between the one or more vertical slits and the internal rear panel.

12. The oven appliance of claim 11, wherein the sheet of insulation material comprises a first bend and a second bend, wherein the first bend is defined between the front face and the first side face, and wherein the second bend is defined between the front face and the second side face.

13. The oven appliance of claim 12, wherein the second bend is generally parallel to the first bend.

14. The oven appliance of claim 12, wherein the sheet of insulation material further comprises a first set of perforations and a second set of perforations, wherein the first set of perforations are defined at a first bend location corresponding to the first bend, and wherein the second set of perforations are defined at a second bend location corresponding to the second bend.

15. The oven appliance of claim 11, wherein the sheet of insulation material is secured to the chamber duct without utilizing external fasteners.

16. The oven appliance of claim 11, wherein the sheet of insulation material is secured to the chamber duct without the sheet of insulation material engaging with itself.

17. The oven appliance of claim 11, wherein the chamber duct defines a plurality of sides, the plurality of sides comprising a front wall, a rear wall, a first side wall, and a second side wall, wherein the sheet of insulation material is secured to less than all sides of the plurality of sides of the chamber duct.

18. The oven appliance of claim 11, wherein the cooking chamber comprises a top wall, wherein the cabinet comprises an exhaust trim piece at a top side and a rear of the cabinet, and wherein the chamber duct is extended between the top wall of the cooking chamber and the exhaust trim piece.
